(19) United States
(12) Patent Application Publication
(10) Pub. No.: US 2016/0080501 A1
(43) Pub. Date: Mar. 17, 2016

(54) ON DEMAND CUSTOMER PRIVATE NETWORK CONNECTIVITY BETWEEN CLOUD DATA CENTERS

(71) Applicant: INTERNATIONAL BUSINESS MACHINES CORPORATION, Armonk, NY (US)

(72) Inventors: Douglas M. Freimuth, New York, NY (US); Lap T. Huynh, Cary, NC (US); Jeffrey A. Sanden, Camp Hill, PA (US)

(21) Appl. No.: 14/485,839

(22) Filed: Sep. 15, 2014

(51) Int. Cl. H04L 29/08; H04L 29/06

(52) U.S. Cl. CPC H04L 67/141; H04L 63/04

(57) ABSTRACT

An approach is provided for establishing a private network connection between source and target cloud data centers (CDCs). Requirements of the private network connection are received. Network service providers (NSPs) providing a network service to the source and target CDCs are determined. Performance information of respective NSPs is determined. Performance information of NSP(s) are determined to satisfy the requirements. One of the NSP(s) is selected based on the corresponding performance information optimally satisfying the requirements. First and second connection endpoints of the private network connection are generated in the source and target CDCs, respectively. Based on the first and second connection endpoints and responsive to a request from the target CDC to the selected NSP to attach the target CDC to the private network connection, the private network connection is established.

### TECHNICAL FIELD

The present invention relates to establishing connectivity between cloud data centers, and more particularly to dynamically and automatically establishing best path network connectivity between cloud data centers.

### BACKGROUND

Enterprises that are adopting private, public, and hybrid cloud computing, deploying geographically distributed virtual data centers, employing Software Defined Networking (SDN), and/or using applications such as storage replication and synchronization, virtual machine image transfer and migration, and distributed applications need on-demand network services and connectivity to avoid costly reliance on fixed network connectivity or over provisioning network connectivity across virtual data centers. Network service providers provide on-demand connectivity along with value-added virtualized networking services such as wide area network (WAN) acceleration and a virtual private network (VPN). The on-demand connectivity requires automation and orchestration and may employ emerging technologies such as Network Function Virtualization (NFV).

### BRIEF SUMMARY

In first embodiments, the present invention provides a method of establishing a private network connection between a source cloud data center (CDC) and a target CDC. The method includes a computer receiving requirements of the private network connection between the source and target CDCs. The requirements specify at least one of: a delay, a bandwidth, security, and a virtualized networking service required by a customer. The method further includes the computer determining a set of network service providers (NSPs) that provide a network service to the source and target CDCs. The method further includes the computer determining performance information of respective NSPs in the set of NSPs. The performance information of an NSP specifies at least one of: a delay, a bandwidth, security, and a virtualized networking service provided by the NSP. The method further includes the computer determining whether the performance information of one or more NSPs in the set of NSPs satisfies the received requirements. The method further includes, based in part on the performance information of the one or more NSPs satisfying the received requirements, the computer selecting an NSP included in the one or more NSPs whose performance information optimally satisfies the received requirements. The method further includes the computer generating in the source CDC a first connection endpoint of the private network connection by sending a request to the selected NSP to attach the source CDC to the private network connection. The method further includes the computer generating in the target CDC a second connection endpoint of the private network connection by sending a request to the target CDC to attach the target CDC to the private network connection. The method further includes, based on the first and second connection endpoints being generated and in response to a request from the target CDC to the selected NSP to attach the target CDC to the private network connection, the computer establishing the private network connection between the source and target CDCs.

In a second embodiment, the present invention provides a computer program product including a computer-readable storage device and a computer-readable program code stored in the computer-readable storage device. The computer-readable program code includes instructions that are executed by a central processing unit (CPU) of a computer system to implement a method of establishing a private network connection between a source CDC and a target CDC. The method includes computer system receiving requirements of the private network connection between the source and target CDCs. The requirements specify at least one of: a delay, a bandwidth, security, and a virtualized networking service required by a customer. The method further includes the computer system determining a set of network service providers (NSPs) that provide a network service to the source and target CDCs. The method further includes the computer system determining performance information of respective NSPs in the set of NSPs. The performance information of an NSP specifies at least one of: a delay, a bandwidth, security, and a virtualized networking service provided by the NSP. The method further includes the computer system determining whether the performance information of one or more NSPs in the set of NSPs satisfies the received requirements. The method further includes, based in part on the performance information of the one or more NSPs satisfying the received requirements, the computer system selecting an NSP included in the one or more NSPs whose performance information optimally satisfies the received requirements. The method further includes the computer system generating in the source CDC a first connection endpoint of the private network connection by sending a request to the selected NSP to attach the source CDC to the private network connection. The method further includes the computer system generating in the target CDC a second connection endpoint of the private network connection by sending a request to the target CDC to attach the target CDC to the private network connection. The method further includes, based on the first and second connection endpoints being generated and in response to a request from the target CDC to the selected NSP to attach the target CDC to the private network connection, the computer system establishing the private network connection between the source and target CDCs.

In a third embodiment, the present invention provides a computer system including a central processing unit (CPU); a memory coupled to the CPU; and a computer-readable storage device coupled to the CPU. The storage device includes instructions that are executed by the CPU via the memory to implement a method of establishing a private network connection between a source CDC and a target CDC. The method includes the computer system receiving requirements of the private network connection between the source and target CDCs. The requirements specify at least one of: a delay, a bandwidth, security, and a virtualized networking service required by a customer. The method further includes the computer system determining a set of network service providers (NSPs) that provide a network service to the source and target CDCs. The method further includes the computer system determining performance information of respective NSPs in the set of NSPs. The performance information of an NSP specifies at least one of: a delay, a bandwidth, security, and a virtualized networking service provided by the NSP. The method further includes the computer system determining whether the performance information of one or more NSPs in the set of NSPs satisfies the received requirements. The method further includes, based in part on the performance information of the one or more NSPs satisfying the received requirements, the computer system selecting an NSP included in the one or more NSPs whose performance information optimally satisfies the received requirements. The method further includes the computer system generating in the source CDC a first connection endpoint of the private network connection by sending a request to the selected NSP to attach the source CDC to the private network connection. The method further includes the computer system generating in the target CDC a second connection endpoint of the private network connection by sending a request to the target CDC to attach the target CDC to the private network connection. The method further includes, based on the first and second connection endpoints being generated and in response to a request from the target CDC to the selected NSP to attach the target CDC to the private network connection, the computer system establishing the private network connection between the source and target CDCs.

Embodiments of the present invention automatically and dynamically determine for a customer an optimal private connection between different cloud data centers based on requirements of a customer, where the requirements specify required performance attributes the private connection and may specify cost constraints of the customer.

### BRIEF DESCRIPTION OF THE DRAWINGS

FIG. 1 is a block diagram of a system for determining an optimal on-demand private network connection between source and target cloud data centers, in accordance with embodiments of the present invention.

FIG. 2 is a flowchart of a process of determining an optimal on-demand private network connection between source and target cloud data centers, where the process is implemented in the system of FIG. 1, in accordance with embodiments of the present invention.

FIGS. 3A-3C depict steps of determining an optimal on-demand private network connection between source and target cloud data centers included in the process of FIG. 2, in accordance with embodiments of the present invention.

FIG. 4 is a block diagram of a computer that is included in the system of FIG. 1 and that implements the process of FIG. 2, in accordance with embodiments of the present invention.

### DETAILED DESCRIPTION

### Overview

Embodiments of the present invention provide an automatic, on demand determination of an optimal cloud-to-cloud path between different cloud service providers (CSPs) over different network service providers (NSPs) to satisfy a customer's requirements, which may or may not include cost constraints. An embodiment of the present invention dynamically sets up a cloud transport service by gathering information such as delay, bandwidth, security, and virtualized networking services requirements, and possibly cost constraints, to generate a new optimal route from a source cloud to a target cloud, rather than selecting a route from other, pre-existing running routes. The new optimal route may be based on a determination of a mapping of wide area network (WAN) service providers' connections for the target cloud and optionally for one or more transit clouds.

Known products and techniques that address route/path optimization, shortest path, bi-criteria path selection, and enhancement of routing protocols do not solve the problem of dynamically determining an optimal private network connection for customers to connect their environments between different clouds in cases in which there are multiple cloud providers, where each of the cloud providers can be connected to multiple network service providers (e.g., peering partners). The failure to address the aforementioned problem presents a unique challenge to enterprises that are trying to avoid known, costly techniques for providing on demand network connectivity. This unique challenge is overcome by one or more embodiments of the present invention. As used herein, a private network connection is defined as a connection in a network established and operated by a private organization or corporation for users within that organization or corporation.

System for Determining an Optimal on-Demand Private Network Connection Between Cloud Data Centers

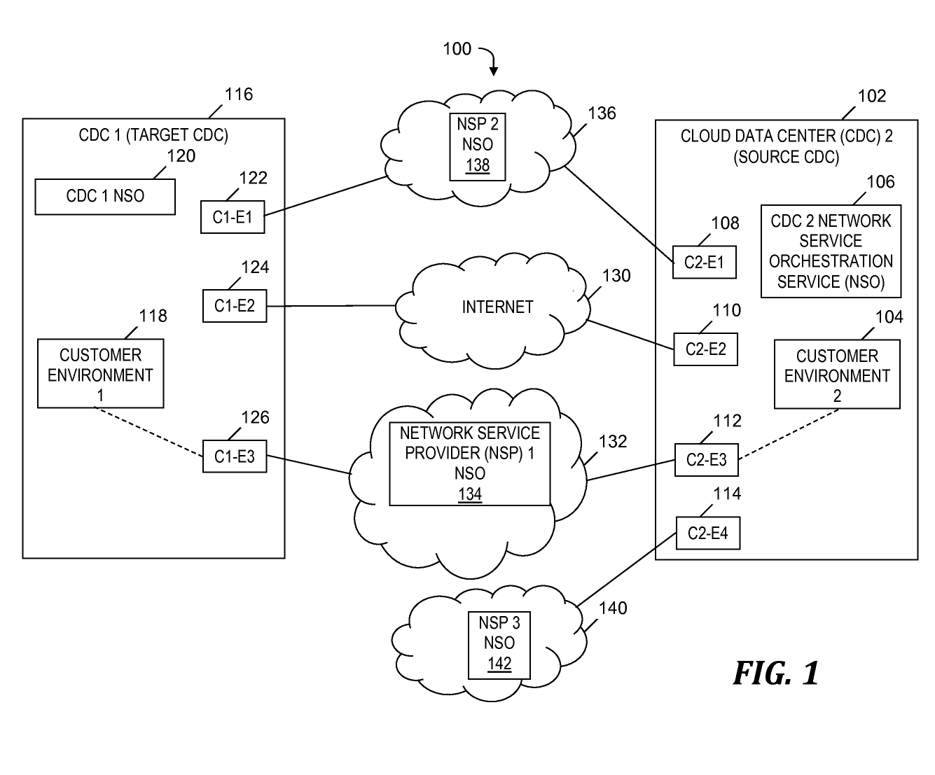

FIG. 1 is a block diagram of a system 100 for determining an optimal on-demand private network connection between source and target cloud data centers, in accordance with embodiments of the present invention. System 100 includes a source cloud data center (CDC) 102, which includes a customer environment 104 that includes a customer's resources based in a source cloud. The source cloud is a public cloud, a private cloud, or a hybrid cloud. Source CDC 102 is also referred to herein as CDC 2 or CDC2. A computer (not shown) included in CDC 102 runs a software-based network service orchestration service (NSO) 106 (i.e., CDC 2 NSO). A CDC is a location from which a cloud service is delivered to a customer by a cloud service provider. The cloud service is delivered via a public cloud, a private cloud, or a hybrid cloud. An NSO is a service that automatically provisions and manages a customer's connectivity in an infrastructure of a network service provider (NSP) and an infrastructure of the customer. Software running in the customer environment to provide an NSO may be different from software running in the provider environment to provide an NSO. Source CDC 102 includes edge connections 108, 110, 112 and 114 which are provided by edge devices and which are also referred to herein as C2-E1, C2-E2, C2-E3 and C2-E4, respectively.

System 100 includes a target CDC 116, which includes a customer environment 118 that includes the aforementioned customer's resources based in a target cloud, which is different from the source cloud. The target cloud is a public cloud, a private cloud, or a hybrid cloud. Target CDC 116 is also referred to herein as CDC 1 or CDC 1. CDC 102 and CDC 116 may be provided by two different cloud service providers, or may be different data centers provided by a single cloud service provider. A computer (not shown) included in CDC 116 runs a software-based network service orchestration service (NSO) 120 (i.e., CDC 1 NSO). Target CDC 116 includes edge connections 122, 124, and 126, which are provided by edge devices and which are also referred to herein as C1-E1, C1-E2, and C1-E3, respectively.

A primary connection between source CDC 102 and target CDC 116 is via the Internet 130, using a connection (not shown) from customer environment 104 to edge C2-E2, which is connected to Internet 130, and using another connection (not shown) from customer environment 118 to edge C1-E2, which is connected to Internet 130. A first NSP (i.e., NSP 1) provides a first network 132, to which connections are managed by an NSO 134 (i.e., NSP 1 NSO). A second NSP (i.e., NSP 2) provides a second network 136, to which connections are managed by an NSO 138 (i.e., NSP 2 NSO). A third NSP (i.e., NSP 3) provides a third network 140, to which connections are managed by an NSO 142 (i.e., NSP 3 NSO). The cloud service provider providing source CDC 102 or target CDC 116 may be the same as or different from each of the first, second and third NSPs providing networks 132, 136 and 140, respectively. Each of the NSPs shown in FIG. 1, such as NSP 132, may be a single NSP or multiple NSPs that are chained together, or otherwise interconnected, to form a transit cloud of NSPs.

Although system 100 includes the first, second and third networks, embodiments of the present invention may include any plurality of networks, where source CDC 102 connects to one or more of the networks in the plurality of networks and target CDC 116 connects to one or more of the networks in the plurality of networks, where the one or more networks to which CDC 102 may be connected may be the same or different from the one or more networks to which CDC 116 may be connected.

Source CDC 102 and target CDC 116 may connect to the first network via edges C2-E3 and C1-E3, respectively. Source CDC 102 and target CDC 116 may connect to the second network via edges C2-E1 and C1-E1, respectively. Source CDC 102 may connect to the third network via edge C2-E4. Target CDC 116 cannot connect to the third network provided by NSP 3.

The dotted lines connecting customer environment 104 to C2-E3 and customer environment 118 to C1-E3, thereby connecting CDC 102 to CDC 116 via network 132 are portions of a private network connection established on-demand by embodiments of the present invention.

Although system 100 includes two CDCs, embodiments of the present invention may include more than two CDCs, where one or more of the CDCs may serve as transit CDC(s) between source CDC 102 and target CDC 116 in a determination of a best path from source CDC 102 to target CDC 116.

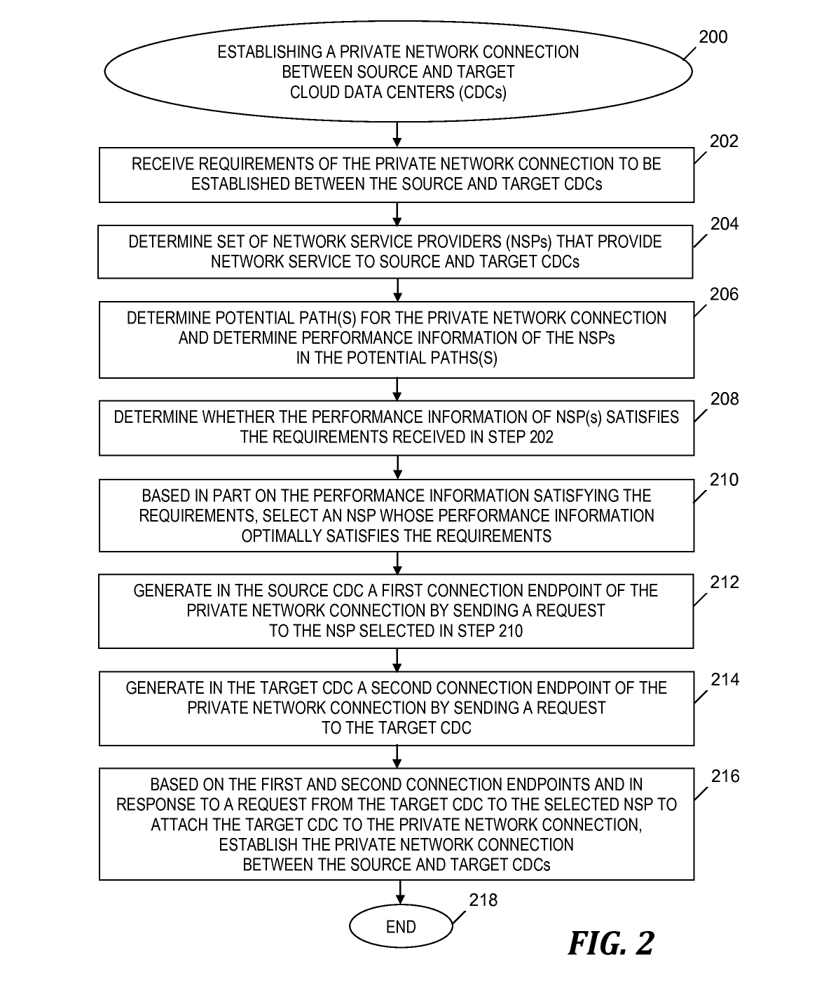

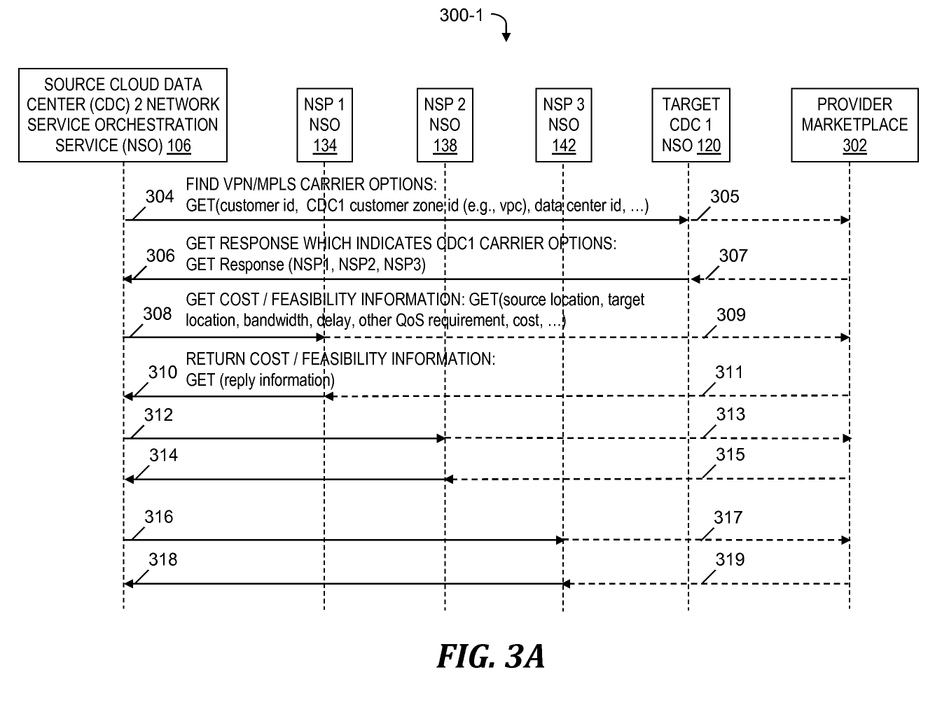

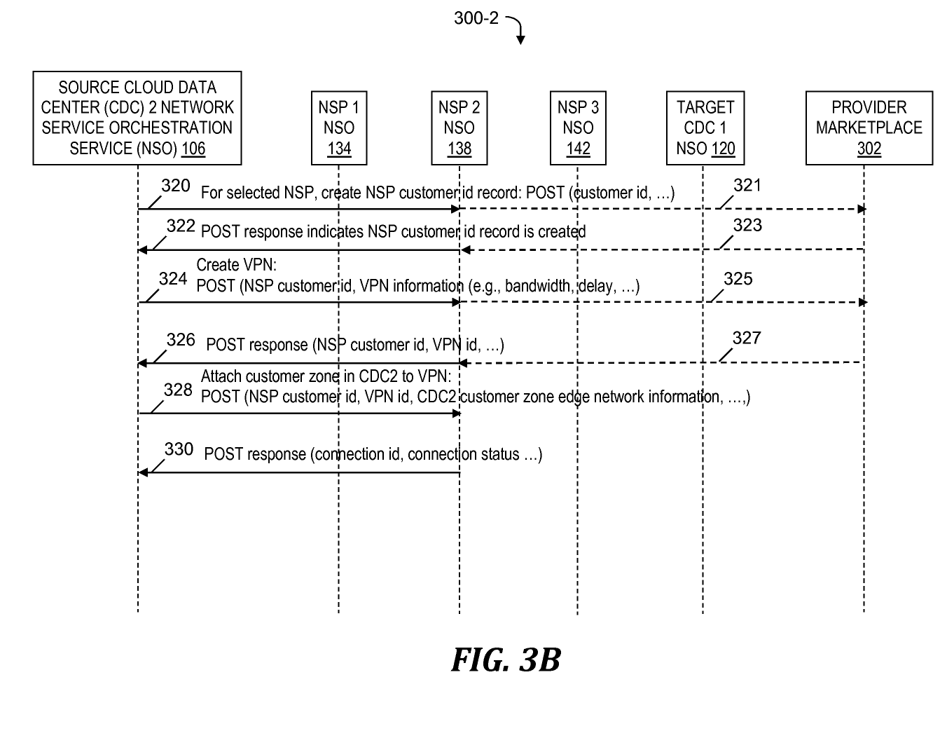

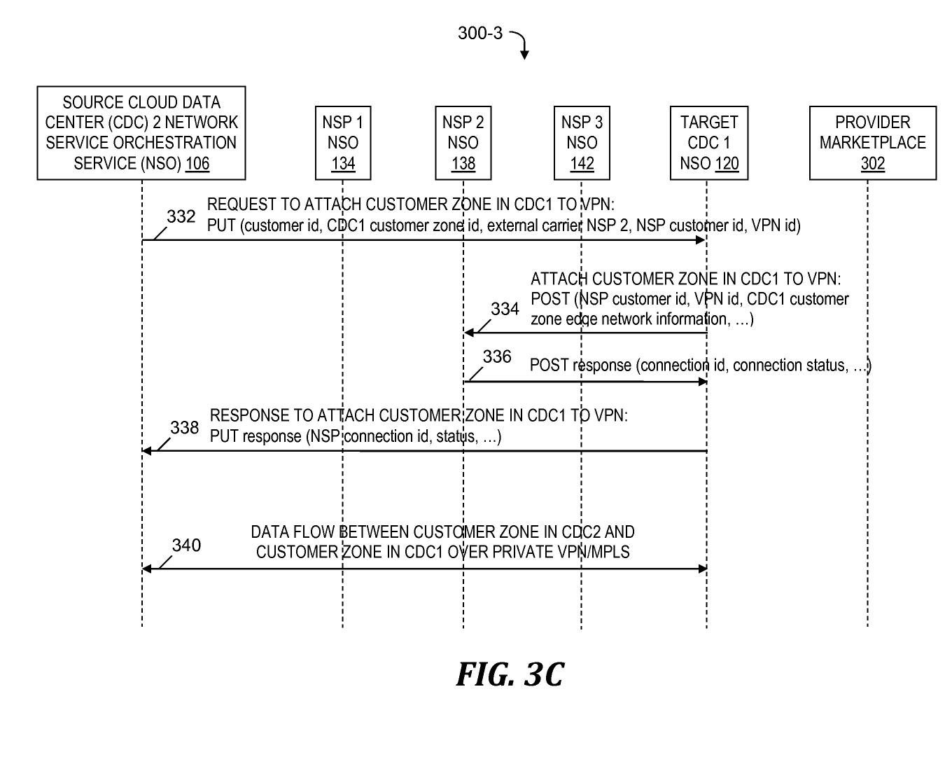

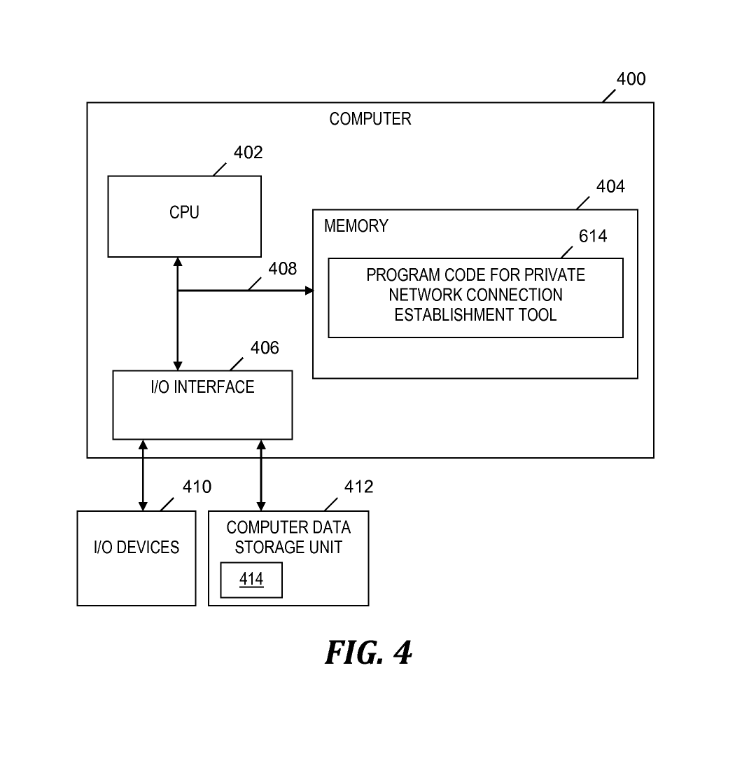

The functionality of the components shown in FIG. 1 is described in more detail in the discussion of FIG. 2, FIGS. 3A-3C, and FIG. 4 presented below.

Process for Determining an Optimal on-Demand Private Network Connection Between Cloud Data Centers

FIG. 2 is a flowchart of a process of determining an optimal on-demand private network connection between source and target cloud data centers, where the process is implemented in the system of FIG. 1, in accordance with embodiments of the present invention. The process of FIG. 2 starts at step 200. Prior to step 202, CDC 2 NSO 106 (see FIG. 1) receives an on-demand request manually entered from a command line by a customer of source CDC 102 (see FIG. 1) to establish a private network connection between a first virtualized isolated environment (i.e., customer environment 104 in FIG. 1; also known as a customer zone) within a first cloud and a second virtualized isolated environment (i.e., customer environment 118 in FIG. 1) within a second cloud. Alternatively, CDC 2 NSO 106 (see FIG. 1) automatically generates the request to establish the private network connection in response to CDC 2 NSO 106 (see FIG. 1) detecting an overload condition of resources in customer environment 104 (see FIG. 1).

In step 202, CDC 2 NSO 106 (see FIG. 1) receives requirements of the private network connection whose establishment was requested by the aforementioned on-demand request. In one embodiment, the requirements received in step 202 include at least one of the following requirements: delay, bandwidth, security, virtualized networking services, and cost constraints. In another embodiment, the requirements received in step 202 include at least one of the following requirements: delay, bandwidth, security, and virtualized networking services, but not cost constraints. Duration (i.e., the minimum length of time the on-demand private network connection must be available) may also be included in the requirements.

In one embodiment, the delay requirement is a maximum measure of latency of the private network connection. For example, the delay may indicate that the latency of the private network connection cannot exceed 100 milliseconds.

In one embodiment, the bandwidth requirement is a minimum amount of data that is required to be transferred in a specified amount of time (e.g., the bandwidth must be at least two gigabits per second).

In one embodiment, the security requirement is a method of encrypting data that must be applied to data that is being transferred across the private network connection.

In one embodiment, the virtualized networking services requirement provide optimization services (e.g., wide area optimization) which deploy appliances at both ends of the private network connection to enhance the speed of data transferred across the private network connection. For example, the appliances may provide data compression.

In step 204, CDC 2 NSO 106 (see FIG. 1) determines a set of NSPs by determining the edge connections from source CDC 102 (see FIG. 1) to networks that source CDC 102 (see FIG. 1) can access (i.e., determining the edge connections C2-E1, C2-E2, C2-E3 and C2-E4, which access networks 136, 130, 132 and 140, respectively, as shown in FIG. 1), and by determining the edge connections from target CDC 116 (see FIG. 1) to networks that target CDC 116 (see FIG. 1) can access (i.e., determining the edge connections C1-E1, C1-E2, and C1-E3, which access networks 136, 130 and 132, respectively, as shown in FIG. 1). Each NSP in the set determined in step 204 provides network service to (1) source CDC 102 (see FIG. 1) and target CDC 116 (see FIG. 1) (i.e., the NSP is a common carrier), (2) source CDC 102 (see FIG. 1), but not to target CDC 116 (see FIG. 1), or (3) target CDC 116 (see FIG. 1), but not to source CDC 102 (see FIG. 1).

In step 206, CDC 2 NSO 106 (see FIG. 1) determines potential path(s) for the private network connection and determines performance information (i.e., attributes that match the requirements received in step 202) of private network connections provided by the NSP(s) in the potential paths. To determine the potential path(s), CDC 2 NSO 106 (see FIG. 1) identifies the common carrier(s) and any transit cloud(s) or any interconnections between networks. The common carrier(s) are NSP(s) included in the set determined in step 204, where each of the common carrier(s) provides a network service to both source CDC 102 (see FIG. 1) and target CDC 116 (see FIG. 1). In FIG. 1, NSP 1 and NSP 2 are common carriers because of the connection between C2-E3 and C1-E3 via NSP 1 and the connection between C2-E1 and C1-E1 via NSP 2. The identified common carrier(s) provide respective path(s) from source CDC 102 (see FIG. 1) to target CDC 116 (see FIG. 1).

One or more transit clouds may provide respective path(s) between source CDC 102 (see FIG. 1) and target CDC 116 (see FIG. 1). If the one or more transit clouds exist, CDC 2 NSO 106 (see FIG. 1) identifies the one or more transit clouds and CDC 2 NSO 106 (see FIG. 1) and their respective path(s) and includes the path(s) in the potential path(s) determined in step 206.

A plurality of NSPs may have agreements by which their respective networks are interconnected so that path(s) between source CDC 102 (see FIG. 1) and target CDC 116 (see FIG. 1) may include connections between interconnected networks. If interconnected networks exist, CDC 2 NSO 106 (see FIG. 1) identifies the interconnected networks and the path(s) that utilize the interconnected networks, CDC 2 NSO 106 (see FIG. 1) includes the path(s) in the potential path(s) determined in step 206.

In one embodiment, the CDC 2 NSO 106 (see FIG. 1) determines the performance information by requesting the performance information from the different NSPs in the potential path(s) determined in step 206 (e.g., requesting the performance information of private network connections provided by NSP 1, NSP 2 and NSP 3, which provide network services in networks 132, 136, and 140, respectively, in FIG. 1).

In an alternate embodiment, CDC 2 NSO 106 (see FIG. 1) requests the performance information from a carrier marketplace entity (not shown in FIG. 1) (also known as carrier marketplace or provider marketplace). The carrier marketplace entity acts a broker who negotiates with the NSPs to obtain potential private network connection(s) from one or more NSPs, where the attributes of the private network connection(s) satisfy the requirements received in step 202. The carrier marketplace entity is different from the NSPs, the customer and the entity or entities that manage CDCs (e.g., different from the NSPs providing network services via networks 132, 136, and 140, respectively, in FIG. 1, and different from the entity or entities that manage CDC 102 (see FIG. 1) and CDC 116 (see FIG. 1)).

In step 208, CDC 2 NSO 106 (see FIG. 1) determines whether the performance information of private network connections provided by the NSP(s) in the potential paths determined in step 206 satisfies the requirements received in step 202. Alternatively, the carrier marketplace entity determines the NSP(s) that can provide private network connection(s) whose performance information satisfies the requirements received in step 202.

In step 210, based in part on a determination in step 208 that performance information satisfies the requirements received in step 202, CDC 2 NSO 106 (see FIG. 1) selects an NSP from the NSP(s) that are in the potential path(s) determined in step 206 and that provide private network connection(s) whose performance information satisfies the requirements received in step 202. The selected NSP is the NSP that provides a private network connection between source CDC 102 (see FIG. 1) and target CDC 116 (see FIG. 1) whose performance information optimally satisfies the requirements received in step 202. In one embodiment, CDC 2 NSO 106 (see FIG. 1) determines the performance information that optimally satisfies the requirements by determining a solution to an optimization problem based on the requirements received in step 202 and the performance information determined in step 206.

In step 212, CDC 2 NSO 106 (see FIG. 1) generates in source CDC 102 (see FIG. 1) a first connection endpoint of the private network connection by sending request(s) to the NSP selected in step 210. The first connection endpoint is customer environment 104 (see FIG. 1), which is the endpoint of a connection to C2-E3 112 (see FIG. 1). In one embodiment, the requests sent in step 212 identify the customer whose environment 104 (see FIG. 1) is to be connected via the private network connection, create a virtual private network in the network via which the selected NSP provides network services, and attaches customer environment 104 (see FIG. 1) to the virtual private network. The virtual private network is the aforementioned private network connection.

In step 214, CDC 2 NSO 106 (see FIG. 1) generates in target CDC 116 (see FIG. 1) a second connection endpoint of the private network connection by sending a request to CDC 1 NSO 120 (see FIG. 1). The second connection endpoint is customer environment 118 (see FIG. 1), which is the endpoint of a connection to C1-E3 126 (see FIG. 1). In one embodiment, the request sent in step 214 initiates an attachment of customer environment 118 (see FIG. 1) to the virtual private network created in step 212. Attaching customer environment 118 (see FIG. 1) to the virtual private network includes CDC 1 NSO 120 (see FIG. 1) sending a request to the selected NSP to complete the attachment of customer environment 118 (see FIG. 1) to the virtual private network.

In step 216, based on the first and second connection endpoints generated in steps 212 and 214, respectively, and in response to a request from target CDC 116 (see FIG. 1) to the NSP selected in step 210 to attach customer environment 118 (see FIG. 1) to the private network connection, CDC 2 NSO 106 (see FIG. 1) establishes a complete private network connection between source CDC 102 (see FIG. 1) and target CDC 116 (see FIG. 1). The process of FIG. 2 ends at step 218.

FIGS. 3A-3C depict steps of determining an optimal on-demand private network connection between first and second cloud data centers included in the process of FIG. 2, in accordance with embodiments of the present invention. Portions of steps 300-1, 300-2, and 300-3 are depicted in FIG. 3A, FIG. 3B, and FIG. 3C, respectively, and include requests that originate with or are received by CDC 2 NSO 106, NSP 1 NSO 134, NSP 2 NSO 138, NSP 3 NSO 142, CDC 1 NSO 120, and provider marketplace 302.

In step 304, CDC 2 NSO 106 sends a request to CDC 1 NSO 120 to find VPN or Multiprotocol Label Switching (MPLS) carrier options. The request includes an identification of the customer who is requesting an establishment of a private network connection between source CDC 102 (see FIG. 1) and target CDC 116 (see FIG. 1), an identification of a customer zone in target CDC 116 (see FIG. 1) (i.e., an identification of customer environment 118 in FIG. 1) (e.g., an identification of a virtual private cloud (vpc)), and an identification of target CDC 116 (see FIG. 1). Alternatively, the request sent in step 304 can be sent to provider marketplace 302, as shown in step 305.

In step 306, CDC 1 NSO 120 sends to CDC 2 NSO 106 a response to the request sent in step 304. The response includes identifications of NSP 1, NSP 2, and NSP 3, which are the VPN or MPLS carrier options for target CDC 116 (see FIG. 1). Alternatively, the response sent in step 306 can be sent from provider marketplace 302, as shown in step 307, which is a response to the alternate request sent to provider marketplace 302 in step 305.

In step 308, CDC 2 NSO 106 sends a request to NSP 1 NSO 134 to obtain feasibility information and the cost of NSP 1 providing the requested private network connection. The request includes a request for source and target locations, bandwidth, delay, one or more other quality of service (QoS) requirements, and the cost of the private network connection. Alternatively, the request sent in step 308 can be sent to provider marketplace 302, as shown in step 309.

In step 310, NSP 1 NSO 134 sends to CDC 2 NSO 106 a response to the request sent in step 308. The response includes the requested information, including the source and target locations, bandwidth, delay, one or more other QoS requirements, and the cost of the private network connection that NSP 1 can provide. Alternatively, the response sent in step 310 can be sent from provider marketplace 302, as shown in step 311, which is a response to the alternate request sent in step 309.

In step 312, CDC 2 NSO 106 sends a request to NSP 2 NSO 138 to obtain feasibility information and the cost of NSP 2 providing the requested private network connection. The request includes a request for source and target locations, bandwidth, delay, one or more other QoS requirements, and the cost of the private network connection. Alternatively, the request sent in step 312 can be sent to provider marketplace 302, as shown in step 313.

In step 314, NSP 2 NSO 138 sends to CDC 2 NSO 106 a response to the request sent in step 312. The response includes the requested information, including the source and target locations, bandwidth, delay, one or more other QoS requirements, and the cost of the private network connection that NSP 2 can provide. Alternatively, the response sent in step 314 can be sent from provider marketplace 302, as shown in step 315, which is a response to the alternate request sent in step 313.

In step 316, CDC 2 NSO 106 sends a request to NSP 3 NSO 142 to obtain feasibility information and the cost of NSP 3 providing the requested private network connection. The request includes a request for source and target locations, bandwidth, delay, one or more other QoS requirements, and the cost of the private network connection. Alternatively, the request sent in step 316 can be sent to provider marketplace 302, as shown in step 317.

In step 318, NSP 3 NSO 142 sends to CDC 2 NSO 106 a response to the request sent in step 316. The response includes the requested information, including the source and target locations, bandwidth, delay, one or more other QoS requirements, and the cost of the private network connection that NSP 3 can provide. Alternatively, the response sent in step 318 can be sent from provider marketplace 302, as shown in step 319, which is a response to the alternate request sent in step 317.

After step 318 (or alternately, step 319), and before step 320 in FIG. 3B, CDC 2 NSO 106 selects NSP 2 instead of NSP 1 or NSP 3, because CDC 2 NSO 106 compares paths via the three networks provided by NSP 1, NSP 2 and NSP 3, and determines that the path via the network provided by NSP 2 is the optimal path between source CDC 102 (see FIG. 1) and target CDC 116 (see FIG. 1). The optimality of the path is based on the cost and feasibility information provided by NSP 2 NSO 138 in step 314 (or alternately, provided by provider marketplace 302 in step 315) optimally satisfying the requirements of the customer. In one embodiment, optimally satisfying the requirements of the customer means a path provided by a NSP satisfies all the requirements of the customer and provides the path at a cost that is lower than the cost of providing the path by any other NSP being considered.

For example, the customer requests an MPLS path having the requirements: a minimum committed bandwidth of 12 gigabits per second, a delay that does not exceed 200 milliseconds, a cost that does not exceed C dollars, and a duration of less than 4 hours. Carriers ABC and DEF are carrier options between source CDC 102 (see FIG. 1) and target CDC 116 (see FIG. 1). If Carrier ABC returns a response that indicates a path can be provided that meets all the customer requirements for a cost of Y dollars, where Y=C. Carrier DEF returns a response that indicates a path can be provided that meets all the customer requirements, but the cost is X, where X<C. Because Carrier DEF can provide a path that meets the requirements at a cost that is less than the cost of the path that can be provided by Carrier ABC, CDC 2 NSO 106 selects Carrier DEF instead of Carrier ABC.

In step 320 in FIG. 3B, CDC 2 NSO 106 sends a request to the selected NSP (i.e., to NSP 2 NSO 138) to create an NSP customer identification (ID) record that includes an NSP customer ID which identifies the selected NSP and the customer. The request includes the identification of the customer. Alternatively, the request sent in step 320 can be sent to provider marketplace 302, as shown in step 321.

In step 322, NSP 2 NSO 138 sends to CDC 2 NSO 106 a response to the request sent in step 320. The response indicates that the NSP customer ID record has been created. Alternatively, the response sent in step 322 can be sent from provider marketplace 302, as shown in step 323, which is a response to the alternate request sent in step 321.

In step 324, CDC 2 NSO 106 sends a request to NSP 2 NSO 138 to create the VPN (i.e., the requested private network connection). The request includes the NSP customer ID and VPN information, including the bandwidth and delay. Alternately, the request sent in step 324 is sent to provider marketplace 302, as shown in step 325.

In step 326, NSP 2 NSO 138 sends to CDC 2 NSO 106 a response to the request sent in step 324. The response indicates that the VPN has been created and includes the NSP customer ID and an identification of the VPN. Alternately, the response sent in step 326 is sent from provider marketplace 302, as shown in step 327, which is a response to the alternate request sent in step 325.

In step 328, CDC 2 NSO 106 sends a request to NSP 2 NSO 138 to attach customer environment 104 (see FIG. 1) to the VPN created in step 324 (or alternately, in step 325). The request includes the NSP customer ID, the identification of the VPN, and information specifying the edge connection (i.e., C2-E3 112 in FIG. 1) from customer environment 104 (see FIG. 1) to network 132 (see FIG. 1).

In step 330, NSP 2 NSO 138 sends to CDC 2 NSO 106 a response to the request sent in step 328. The response indicates that the customer environment 104 (see FIG. 1) has been attached to the VPN. The response includes an identification of the edge connection specified in the request sent in step 328 and a status of the edge connection.

In step 332 in FIG. 3C, CDC 2 NSO 106 sends a request to CDC 1 NSO 120 to attach customer environment 118 (see FIG. 1) to the VPN created in step 324 (see FIG. 3B) (or alternately, in step 325 in FIG. 3B). The request includes the identification of the customer, an identification of customer environment 118 (see FIG. 1), an identification of the selected carrier NSP 2, the NSP customer ID, and the identification of the VPN.

In step 334, CDC 1 NSO 120 sends to NSP 2 NSO 138 a request to attach customer environment 118 (see FIG. 1) to the VPN. The request includes the NSP customer ID, the identification of the VPN, and information specifying the edge connection (i.e., C1-E3 126 in FIG. 1) between customer environment 118 (see FIG. 1) and network 132 (see FIG. 1).

In step 336, NSP 2 NSO 138 sends to CDC 1 NSO 120 a response to the request sent in step 334. The response includes an identification of the edge connection specified in step 334 and indicates a status of the edge connection.

In step 338, CDC 1 NSO 120 sends to CDC 2 NSO 106 a response to the request sent in step 332. The response indicates that the customer environment 118 (see FIG. 1) has been attached to the VPN. The response includes an identification of the connection over the selected NSP (i.e., NSP connection ID) and the status of the connection.

In step 340, the establishment of the VPN is complete and data flows between customer environment 104 (see FIG. 1) in source CDC 102 (see FIG. 1) and customer environment 118 (see FIG. 1) in target CDC 116 (see FIG. 1) over the VPN.

### Computer System

FIG. 4 is a block diagram of a computer that is included in the system of FIG. 1 and that implements the process of FIG. 2, in accordance with embodiments of the present invention. Computer 400 is a computer system that generally includes a central processing unit (CPU) 402, a memory 404, an input/output (I/O) interface 406, and a bus 408. Further, computer 400 is coupled to I/O devices 410 and a computer data storage unit 412. In one embodiment, computer 400 (not shown in FIG. 1) is included in source CDC 102 (see FIG. 1) and runs CDC NSO 106 (see FIG. 1). CPU 402 performs computation and control functions of computer 400, including carrying out instructions included in program code 414 to perform a method of establishing a private network connection between source and target CDCs, where the instructions are carried out by CPU 402 via memory 404. CPU 402 may include a single processing unit, or be distributed across one or more processing units in one or more locations (e.g., on a client and server). Program code 414 includes program code for CDC 2 NSO 106 (see FIG. 1).

Memory 404 includes a known computer readable storage medium, which is described below. In one embodiment, cache memory elements of memory 404 provide temporary storage of at least some program code (e.g., program code 414) in order to reduce the number of times code must be retrieved from bulk storage while instructions of the program code are carried out. Moreover, similar to CPU 402, memory 404 may reside at a single physical location, including one or more types of data storage, or be distributed across a plurality of physical systems in various forms. Further, memory 404 can include data distributed across, for example, a local area network (LAN) or a wide area network (WAN).

I/O interface 406 includes any system for exchanging information to or from an external source. I/O devices 410 include any known type of external device, including a display device, keyboard, etc. Bus 408 provides a communication link between each of the components in computer 400, and may include any type of transmission link, including electrical, optical, wireless, etc.

I/O interface 406 also allows computer 400 to store information (e.g., data or program instructions such as program code 414) on and retrieve the information from computer data storage unit 412 or another computer data storage unit (not shown). Computer data storage unit 412 includes a known computer-readable storage medium, which is described below. In one embodiment, computer data storage unit 412 is a non-volatile data storage device, such as a magnetic disk drive (i.e., hard disk drive) or an optical disc drive (e.g., a CD-ROM drive which receives a CD-ROM disk).

Memory 404 and/or storage unit 412 may store computer program code 414 that includes instructions that are carried out by CPU 402 via memory 404 to establish a private network connection between source and target CDCs. Although FIG. 4 depicts memory 404 as including program code 414, the present invention contemplates embodiments in which memory 404 does not include all of code 414 simultaneously, but instead at one time includes only a portion of code 414.

Further, memory 404 includes an operating system (not shown) and may include other systems not shown in FIG. 4. The operating system may be a Linux®-based operating system that runs on CPU 402 and provides control of various components within and/or connected to computer 400. Linux is a registered trademark of Linus Torvalds in the United States, other countries, or both.

Storage unit 412 and/or one or more other computer data storage units (not shown) that are coupled to computer 400 may store the content of mobile-based lexicon 114 (see FIG. 1).

As will be appreciated by one skilled in the art, in a first embodiment, the present invention may be a system; in a second embodiment, the present invention may be a method; and in a third embodiment, the present invention may be a computer program product.

Any of the components of an embodiment of the present invention can be deployed, managed, serviced, etc. by a service provider that offers to deploy or integrate computing infrastructure with respect to establishing a private network connection between source and target CDCs. Thus, an embodiment of the present invention discloses a process for supporting computer infrastructure, where the process includes providing at least one support service for at least one of integrating, hosting, maintaining and deploying computer-readable code (e.g., program code 414) in a computer system (e.g., computer 400) including one or more processors (e.g., CPU 402), wherein the processor(s) carry out instructions contained in the code causing the computer system to establish a private network connection between source and target CDCs. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of establishing a private network connection between source and target CDCs.

While it is understood that program code 414 for establishing a private network connection between source and target CDCs may be deployed by manually loading directly in client, server and proxy computers (not shown) via loading a computer-readable storage medium (e.g., computer data storage unit 412), program code 414 may also be automatically or semi-automatically deployed into computer 400 by sending program code 414 to a central server or a group of central servers. Program code 414 is then downloaded into client computers (e.g., computer 400) that will execute program code 414. Alternatively, program code 414 is sent directly to the client computer via e-mail. Program code 414 is then either detached to a directory on the client computer or loaded into a directory on the client computer by a button on the e-mail that executes a program that detaches program code 414 into a directory. Another alternative is to send program code 414 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 414 is transmitted to the proxy server and then it is stored on the proxy server.

Another embodiment of the invention provides a method that performs the process steps on a subscription, advertising and/or fee basis. That is, a service provider, such as a Solution Integrator, can offer to create, maintain, support, etc. a process of establishing a private network connection between source and target CDCs. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product. The computer program product may include a computer readable storage medium (or media) (memory 404 and computer data storage unit 412) having computer readable program instructions 414 thereon for causing a processor (e.g., CPU 402) to carry out aspects of the present invention.

The computer readable storage medium can be a tangible device that can retain and store instructions (e.g., program code 414) for use by an instruction execution device (e.g., computer 400). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 414) described herein can be downloaded to respective computing/processing devices (e.g., computer 400) from a computer readable storage medium or to an external computer or external storage device (e.g., computer data storage unit 412) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 414) for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2) and/or block diagrams (e.g., FIG. 1 and FIG. 4) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 414).

These computer readable program instructions may be provided to a processor (e.g., CPU 402) of a general purpose computer, special purpose computer, or other programmable data processing apparatus (e.g., computer 400) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 412) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 414) may also be loaded onto a computer (e.g. computer 400), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of establishing a private network connection between a source cloud data center (CDC) and a target CDC, the method comprising the steps of:
a computer receiving requirements of the private network connection between the source and target CDCs, the requirements specifying at least one of: a delay, a bandwidth, security, and a virtualized networking service required by a customer;
the computer determining a set of network service providers (NSPs) that provide a network service to the source and target CDCs;
the computer determining performance information of respective NSPs in the set of NSPs, the performance information of an NSP specifying at least one of: a delay, a bandwidth, security, and a virtualized networking service provided by the NSP;
the computer determining whether the performance information of one or more NSPs in the set of NSPs satisfies the received requirements;
based in part on the performance information of the one or more NSPs satisfying the received requirements, the computer selecting an NSP included in the one or more NSPs whose performance information optimally satisfies the received requirements;
the computer generating in the source CDC a first connection endpoint of the private network connection by sending a request to the selected NSP to attach the source CDC to the private network connection;
the computer generating in the target CDC a second connection endpoint of the private network connection by sending a request to the target CDC to attach the target CDC to the private network connection; and
based on the first and second connection endpoints being generated and in response to a request from the target CDC to the selected NSP to attach the target CDC to the private network connection, the computer establishing the private network connection between the source and target CDCs.

2. The method of claim 1, further comprising the steps of:
the computer receiving cost constraints of the customer; and
the computer determining a cost of the selected NSP providing the private network connection satisfies the received cost constraints, wherein the step of selecting the NSP that optimally satisfies the received requirements is based in part on the cost of the selected NSP satisfying the received cost constraints.

3. The method of claim 1, further comprising the steps of:
the computer determining a first cost of a first NSP providing the private network connection and a second cost of a second NSP providing the private network connection, the first and second NSPs included in the one or more NSPs;
the computer determining the first cost is less than the second cost; and
based on the first cost being less than the second cost, the computer selecting the first NSP as the NSP that optimally satisfies the received requirements.

4. The method of claim 1, further comprising the computer receiving a user request to establish the private network connection or automatically determining an overload condition in a resource of the source CDC, wherein the step of establishing the private network connection is based in part on the user request being received or the overload condition being automatically determined.

5. The method of claim 1, wherein the step of determining the set of NSPs includes determining a mapping of connections to wide area network (WAN) service providers from the source and target CDCs, wherein the step of determining the performance information of the one or more NSPs includes determining performance information of the WAN service provider, wherein the step of determining whether the performance information of the one or more NSPs satisfies the received requirements includes determining the performance information of the WAN service provider satisfies the received requirements, and wherein the step of selecting the NSP includes selecting a connection to a WAN service provider included in the WAN service providers based on the connection to the WAN service provider providing a best path from the source CDC to the target CDC.

6. The method of claim 5, further comprising:
the computer caching performance information about the selected connection to the WAN service provider;
subsequent to the step of establishing the private network connection between the source and target CDCs, the computer receiving a request to establish another private network connection between the source and target CDCs or detecting an overload condition of a resource of the source CDC; and
in response to the request being received or the overload condition being detected, the computer establishing the other private network connection between the source and target CDCs based in part on a re-use of the cached performance information, which prevents a need for a step of re-determining the performance information of the WAN service provider.

7. The method of claim 1, further comprising the computer sending an identification of the selected NSP to the target CDC, wherein the step of sending the request to the target CDC to attach the target CDC to the private network connection is performed in response to the step of sending the identification of the selected NSP.

8. The method of claim 1, further comprising:
the computer determining a first NSP included in the set of NSPs provides a network service to the source CDC and a second NSP included in the set of NSPs provides a network service to the target CDC, the first NSP being different from the second NSP;
the computer determining the first NSP provides a network service to the second NSP via a transit CDC, the transit CDC being different from the source and target CDCs; and
the computer determining that performance information of a path that includes the first and second NSPs connected via the transit CDC satisfies the received requirements,
wherein the step of selecting the NSP includes selecting the first and second NSPs from the one or more NSPs as NSPs connected via the transit CDC that optimally satisfy the received requirements, and
wherein the step of establishing the private network connection is further based on the first NSP being connected to the second NSP via the transit CDC.

9. The method of claim 8, wherein the step of determining the first NSP provides the network service to the second NSP via the transit CDC includes determining a mapping of a connection to a wide area network (WAN) service provider from the transit CDC.

10. The method of claim 8, further comprising:
prior to the step of determining the performance information of the path satisfies the received requirements, the computer determining performance information of the path;
the computer caching the performance information of the path;
subsequent to the step of establishing the private network connection between the source and target CDCs, the computer receiving a request to establish another private network connection between the source and target CDCs or detecting an overload condition of a resource of the source CDC; and
in response to the request being received or the overload condition being detected, the computer establishing the other private network connection between the source and target CDCs based in part on a re-use of the cached performance information, which prevents a need for a step of re-determining the performance information of the path.

11. The method of claim 8, further comprising:
the computer sending an identification of the selected first NSP to the transit CDC; and
in response to the step of sending the identification of the selected first NSP, the computer sending a request to the transit CDC to attach the transit CDC to the private network connection.

12. The method of claim 1, wherein the step of determining performance information of respective NSPs in the set of NSPs is performed in response to a receipt of the performance information from a marketplace entity which is different from the NSPs, the customer, and the source and target CDCs.

13. The method of claim 1, wherein the step of selecting the NSP includes selecting multiple NSPs which are chained together to form a transit cloud, and wherein the step of determining performance information of respective NSPs includes determining performance information of the multiple NSPs which are chained together.

14. A computer program product, comprising:
a computer-readable, storage device; and
a computer-readable program code stored in the computer-readable, storage device, the computer-readable program code containing instructions that are carried out by a central processing unit (CPU) of a computer system to implement a method of establishing a private network connection between a source cloud data center (CDC) and a target CDC, the method comprising the steps of:
the computer system receiving requirements of the private network connection between the source and target CDCs, the requirements specifying at least one of: a delay, a bandwidth, security, and a virtualized networking service required by a customer;
the computer system determining a set of network service providers (NSPs) that provide a network service to the source and target CDCs;
the computer system determining performance information of respective NSPs in the set of NSPs, the performance information of an NSP specifying at least one of: a delay, a bandwidth, security, and a virtualized networking service provided by the NSP;
the computer system determining whether the performance information of one or more NSPs in the set of NSPs satisfies the received requirements;
based in part on the performance information of the one or more NSPs satisfying the received requirements, the computer system selecting an NSP included in the one or more NSPs whose performance information optimally satisfies the received requirements;
the computer system generating in the source CDC a first connection endpoint of the private network connection by sending a request to the selected NSP to attach the source CDC to the private network connection;
the computer system generating in the target CDC a second connection endpoint of the private network connection by sending a request to the target CDC to attach the target CDC to the private network connection; and
based on the first and second connection endpoints being generated and in response to a request from the target CDC to the selected NSP to attach the target CDC to the private network connection, the computer system establishing the private network connection between the source and target CDCs.

15. The computer program product of claim 13, wherein the method further comprises the steps of:
the computer system receiving cost constraints of the customer; and
the computer system determining a cost of the selected NSP providing the private network connection satisfies the received cost constraints, wherein the step of selecting the NSP that optimally satisfies the received requirements is based in part on the cost of the selected NSP satisfying the received cost constraints.

16. The computer program product of claim 13, wherein the method further comprises the steps of:
the computer system determining a first cost of a first NSP providing the private network connection and a second cost of a second NSP providing the private network connection, the first and second NSPs included in the one or more NSPs;
the computer system determining the first cost is less than the second cost; and
based on the first cost being less than the second cost, the computer system selecting the first NSP as the NSP that optimally satisfies the received requirements.

17. The computer program product of claim 13, wherein the method further comprises the computer system receiving a user request to establish the private network connection or automatically determining an overload condition in a resource of the source CDC, wherein the step of establishing the private network connection is based in part on the user request being received or the overload condition being automatically determined.

18. A computer system comprising:
a central processing unit (CPU);
a memory coupled to the CPU; and
a computer readable storage device coupled to the CPU, the storage device containing instructions that are executed by the CPU via the memory to implement a method of establishing a private network connection between a source cloud data center (CDC) and a target CDC, the method comprising the steps of:
the computer system receiving requirements of the private network connection between the source and target CDCs, the requirements specifying at least one of: a delay, a bandwidth, security, and a virtualized networking service required by a customer;
the computer system determining a set of network service providers (NSPs) that provide a network service to the source and target CDCs;
the computer system determining performance information of respective NSPs in the set of NSPs, the performance information of an NSP specifying at least one of: a delay, a bandwidth, security, and a virtualized networking service provided by the NSP;
the computer system determining whether the performance information of one or more NSPs in the set of NSPs satisfies the received requirements;
based in part on the performance information of the one or more NSPs satisfying the received requirements, the computer system selecting an NSP included in the one or more NSPs whose performance information optimally satisfies the received requirements;
the computer system generating in the source CDC a first connection endpoint of the private network connection by sending a request to the selected NSP to attach the source CDC to the private network connection;
the computer system generating in the target CDC a second connection endpoint of the private network connection by sending a request to the target CDC to attach the target CDC to the private network connection; and
based on the first and second connection endpoints being generated and in response to a request from the target CDC to the selected NSP to attach the target CDC to the private network connection, the computer system establishing the private network connection between the source and target CDCs.

19. The computer system of claim 17, wherein the method further comprises the steps of:
the computer system receiving cost constraints of the customer; and
the computer system determining a cost of the selected NSP providing the private network connection satisfies the received cost constraints, wherein the step of selecting the NSP that optimally satisfies the received requirements is based in part on the cost of the selected NSP satisfying the received cost constraints.

20. The computer system of claim 17, wherein the method further comprises the steps of:
the computer system determining a first cost of a first NSP providing the private network connection and a second cost of a second NSP providing the private network connection, the first and second NSPs included in the one or more NSPs;
the computer system determining the first cost is less than the second cost; and
based on the first cost being less than the second cost, the computer system selecting the first NSP as the NSP that optimally satisfies the received requirements.
